(19) United States
(12) Patent Application Publication
(10) Pub. No.: US 2008/0244481 A1
(43) Pub. Date: Oct. 2, 2008

(54) METHOD FOR DESIGNING AND MANUFACTURING SEMICONDUCTOR DEVICE AND SOFTWARE THEREFOR

(75) Inventors: Shigeru Kinoshita, Kanagawa-ken (JP); Shigeyuki Takagi, Kanagawa-ken (JP); Hidehiko Yabuhara, Kanagawa-ken (JP)

Correspondence Address: PEARNE & GORDON LLP, 1801 EAST 9TH STREET, SUITE 1200, CLEVELAND, OH, 44114-3108, US

(73) Assignee: KABUSHIKI KAISHA TOSHIBA, Tokyo (JP)

(21) Appl. No.: 11/859,162

(22) Filed: Sep. 21, 2007

(30) Foreign Application Priority Data
Mar. 28, 2007 (JP) 2007-084955

(51) Int. Cl. G06F 17/50

(52) U.S. Cl. 716/5; 703/14

(57) ABSTRACT

A method for designing a semiconductor device including a semiconductor substrate and an interconnect on the semiconductor substrate, with X-direction being one direction parallel to the semiconductor substrate, Y-direction being a direction parallel to the semiconductor substrate and perpendicular to the X-direction, and Z-direction being perpendicular to the semiconductor substrate, the method includes: determining a cross-sectional configuration in the X-Z direction; three-dimensionalizing the cross-sectional configuration with a range in the Y-direction being specified; and using the three-dimensionalized configuration as a model.

### CROSS-REFERENCE TO RELATED APPLICATIONS

This application is based upon and claims the benefit of priority from the prior Japanese Patent Application No. 2007-084955, filed on Mar. 28, 2007; the entire contents of which are incorporated herein by reference.

### BACKGROUND OF THE INVENTION

1. Field of the Invention

This invention relates to a method for designing a semiconductor device, a manufacturing method based thereon, and a software for causing a computer to function as a simulator, and more particularly to a method for designing a semiconductor device with consideration given to capacitance, resistance, and inductance of the interconnects of the semiconductor device, a manufacturing method based thereon, and a software for causing a computer to function as a simulator.

2. Background Art

With the growing complexity and diversity of semiconductor technologies, simulation-based techniques for analyzing device characteristics are drawing more attention. In particular, there are various proposals of tools for extracting capacitance, resistance, and inductance (hereinafter referred to as RLC) of interconnects. For example, JP-A 2001-028405 (Kokai) (Patent Document 1) discloses a technique for evaluating electrical characteristics of a semiconductor device by reproducing a detailed cross-sectional configuration in which a two-dimensional cross section obtained from process simulation is combined with various semiconductor characteristics obtained from device simulation.

Patent Document 1 relates to a device analysis technique on a two-dimensional cross section. However, with the device being downsized and the configuration being complicated, there is a growing demand for three-dimensional device analysis techniques. The performance of a three-dimensional RLC extraction tool greatly depends on the quality of its function for inputting the interconnect configuration. One of the most typical input methods of a three-dimensional RLC extraction tool is to manually input a simple interconnect configuration as a combination of rectangles. However, in this method, it is difficult to reproduce a realistic configuration conforming to the semiconductor manufacturing process, and features such as “gouge” and “hollow” cannot be reflected in the prediction of electrical characteristics. Furthermore, the workload for inputting a complex configuration becomes enormous, and it is difficult to respond to the complicated configuration of semiconductor devices.

Another input method for a three-dimensional configuration is to calculate a three-dimensional interconnect configuration from a layout pattern using three-dimensional process device simulation. This is a method called a process device simulation in which a completed configuration is predicted by adding the data of the actual process and fabrication, film formation, and other process models to the graphic data based on design values. In this method, a certain level of reality can be reproduced. However, current three-dimensional process device simulators are poorer in fabrication and film formation models than two-dimensional simulators. Hence they have difficulty in reproducing a complex three-dimensional configuration and also take enormous computation time, being unsatisfactory both in computation accuracy and computation speed.

In this respect, JP-A 2000-207433 (Kokai) discloses a technique for reproducing an accurate three-dimensional configuration by extracting parameters for simulating semiconductor device characteristics from a mask data, that is, a method for automatically generating an accurate three-dimensional configuration by extending the mask data in the height direction on the basis of height information. The method of reproducing actual fabrication from a mask data follows the steps similar to those of the above calculation method based on three-dimensional process simulation, and hence has similar problems.

### SUMMARY OF THE INVENTION

According to an aspect of the invention, there is provided a method for designing a semiconductor device including a semiconductor substrate and an interconnect on the semiconductor substrate, with X-direction being one direction parallel to the semiconductor substrate, Y-direction being a direction parallel to the semiconductor substrate and perpendicular to the X-direction, and Z-direction being perpendicular to the semiconductor substrate, the method including: determining a cross-sectional configuration in the X-Z direction; three-dimensionalizing the cross-sectional configuration with a range in the Y-direction being specified; and using the three-dimensionalized configuration as a model.

According to another aspect of the invention, there is provided a method for manufacturing a semiconductor device including a semiconductor substrate and an interconnect on the semiconductor substrate, the interconnect having capacitance, resistance, and inductance component, with X-direction being one direction parallel to the semiconductor substrate, Y-direction being a direction parallel to the semiconductor substrate and perpendicular to the X-direction, and Z-direction being perpendicular to the semiconductor substrate, the method including: determining a cross-sectional configuration in the X-Z direction; three-dimensionalizing the cross-sectional configuration with a range in the Y-direction being specified; using the three-dimensionalized configuration as a model to calculate the capacitance, resistance, and inductance component; and adjusting size of and process for the interconnect so as to optimize the calculated capacitance, resistance, and inductance component.

According to another aspect of the invention, there is provided a software for causing a computer to execute the steps of: calculating a configuration in a Y-Z cross section, with X-direction being one direction parallel to a semiconductor substrate, Y-direction being a direction parallel to the semiconductor substrate and perpendicular to the X-direction, and Z-direction being perpendicular to the semiconductor substrate; extracting a thickness S1 in the Y-direction of a first interconnect and a thickness S2 in the Y-direction of a second interconnect from the configuration in the Y-Z cross section; calculating a configuration of the first interconnect in the X-Z cross section; calculating a configuration of the second interconnect in the X-Z cross section; calculating a three-dimensional configuration of the first interconnect from the thickness S1 and the configuration of the first interconnect in the X-Z cross section; and calculating a three-dimensional configuration of the second interconnect from the thickness S2 and the configuration of the second interconnect in the X-Z cross section.

### BRIEF DESCRIPTION OF THE DRAWINGS

FIG. 1 is a conceptual view showing the method for reproducing an interconnect configuration according to a first embodiment of the invention.

FIG. 2 is a schematic view showing a three-dimensional configuration obtained by a method of manually inputting the configuration of interconnects as simple rectangles (rectangle input method).

FIGS. 3A through 3C schematically show interconnects, FIG. 4 is a conceptual view showing the method for reproducing an interconnect configuration according to a second embodiment of the invention.

FIG. 5 is a conceptual view showing the method for reproducing an interconnect configuration according to a third embodiment of the invention.

FIG. 6 is a conceptual view showing the method for reproducing an interconnect configuration according to a fourth embodiment of the invention.

FIG. 7 is a flow chart showing an RLC extraction calculation method according to the embodiment of the invention.

### DETAILED DESCRIPTION OF THE INVENTION

A method for reproducing an interconnect configuration according to embodiments of the invention will now be described with reference to the drawings.

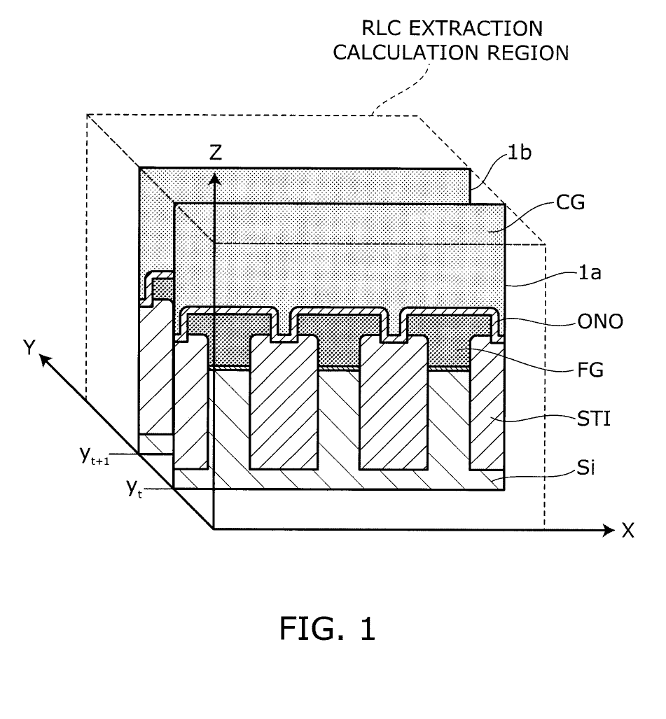

FIG. 1 is a conceptual view showing the method for reproducing an interconnect configuration according to a first embodiment of the invention.

The figure shows a device simulation model for reproducing a three-dimensional configuration of a NAND flash memory. As shown, the X-axis and Y-axis are taken parallel to the silicon substrate surface, and the Z-axis is taken perpendicular thereto. Here, three-dimensionalization is performed by determining a cross-sectional configuration in the X-Z direction and specifying a range (yₜ≦y≦yₜ₊₁) in which this cross-sectional configuration continuously exists along the Y-axis. That is, the cross-sectional configuration 1a has the same configuration as the cross-sectional configuration 1b. Thus the two-dimensional cross section is three-dimensionalized in the range having the same cross-sectional configuration. Within the RLC extraction calculation region shown in the figure, three-dimensionalization is performed by specifying one or more ranges having the same cross-sectional configuration, and the resulting interconnect configurations are combined to reproduce an overall interconnect configuration, which is used for RLC extraction calculation.

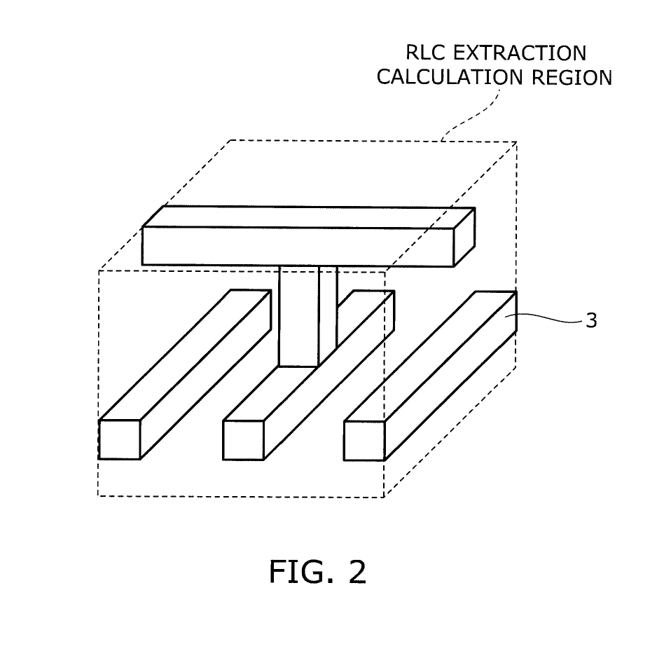

FIG. 2 is a schematic view showing a three-dimensional configuration obtained by a method of manually inputting the configuration of interconnects as simple rectangles (rectangle input method).

In this input method, interconnects 2 are all expressed by prisms. However, actual interconnect configurations have a “rounding” at the corner and a “gouge” and “hollow” occurring in the manufacturing process. On the other hand, a lithography process called such as “slit process” is performed, where the wafer is not etched perpendicularly but shaped in a taper configuration. The rectangle input method cannot realistically reproduce these features. In contrast, the cross-sectional configuration 1a shown in FIG. 1 is calculated by process device simulation, which takes into consideration the models of lithography, doping, oxidation, and diffusion based on process simulation and the models of film formation and etching based on device simulation. Thus the cross-sectional configuration 1a can nearly reproduce the actual cross-sectional configuration.

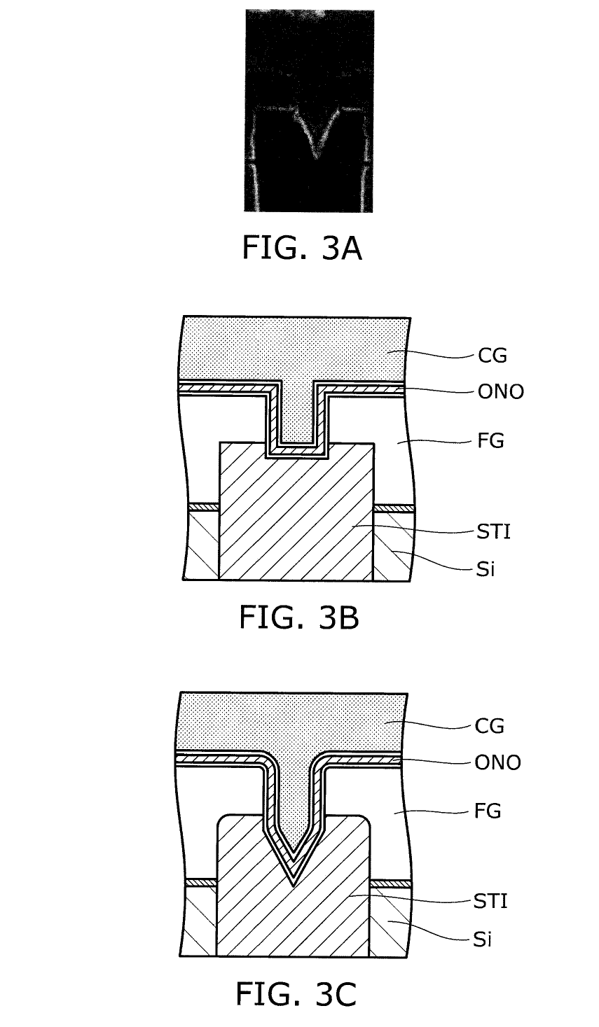

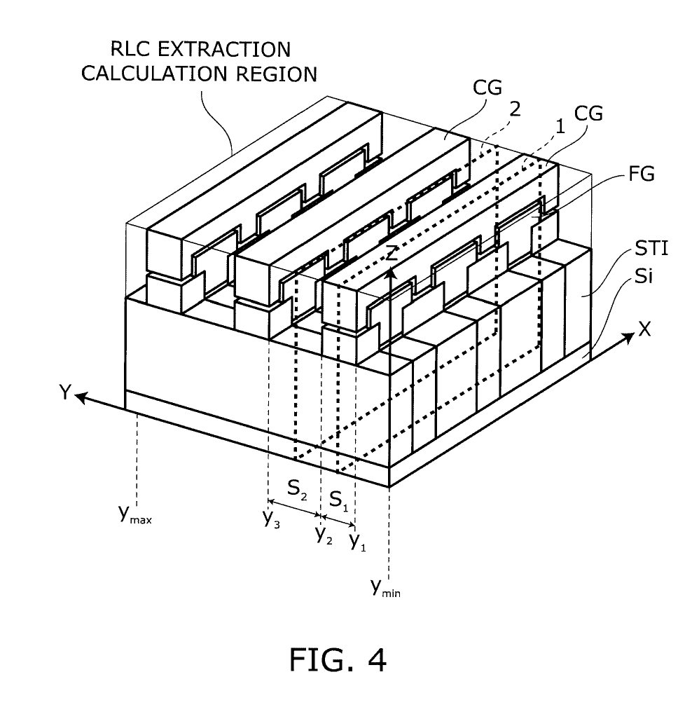

FIGS. 3A through 3C schematically show interconnects, where comparison is made among FIG. 3A showing a cross-sectional photograph of an actual interconnect, FIG. 3B showing an interconnect obtained by the rectangle input method, and FIG. 3C showing an interconnect obtained by process device simulation.

As seen in FIG. 3A, a “gouge” occurring on STI and a “rounding” occurring at the corner of ONO clearly appear in the cross section of the actual interconnect.

The interconnect obtained from a two-dimensional cross section of FIG. 3B obtained by the rectangle input method is all expressed with rectangular features, and hence the “gouge” and “rounding” are not reproduced. In contrast, the interconnect shown in FIG. 3C obtained from a two-dimensional cross section obtained by process device simulation realistically reproduces these features.

As shown in FIG. 1, the interconnect configuration three-dimensionalized using the two-dimensional cross section of FIG. 3B is closer to the actual configuration than the interconnect configuration obtained by the conventional rectangle input method.

Next, the process of three-dimensionalization from a two-dimensional cross section is described in detail.

FIG. 4 is a conceptual view showing the method for reproducing an interconnect configuration according to a second embodiment of the invention.

The figure shows a perspective view of a memory cell section of a NAND flash memory. As in FIG. 1, the X-axis and Y-axis are taken parallel to the silicon substrate surface, and the Z-axis is taken in the height direction. A description is given of the case where three-dimensionalization is performed by using an X-Z cross section as a two-dimensional cross section and specifying a range along the Y-axis.

The RLC extraction calculation region shown in FIG. 4 includes a cross section 1 and a cross section 2. The cross section 1 continuously exists in the range S₁ (y₁≦y≦y₂), and the cross section 2 continuously exists in the range S₂ (y₂≦y≦y₃). In the RLC extraction calculation region, this pattern is repeated for three control gates (CG). Hence, in three-dimensionalization, the three-dimensional configuration obtained by three-dimensionalizing the cross section 1 in the range S₁ (y₁≦y≦y₂) is combined with the three-dimensional configuration obtained by three-dimensionalizing the cross section 2 in the range S₂ (y₂≦y≦y₃). Likewise, three-dimensionalization can be performed in the RLC extraction calculation region (yₘᵢₙ≦y≦yₘₐₓ).

In this embodiment, an X-Z cross section is used as a two-dimensional cross section. However, naturally, three-dimensionalization can be also performed by using a Y-Z cross section as a two-dimensional cross section and specifying a range along the X-axis. Preferably, before three-dimensionalization, both the X-Z cross section and the Y-Z cross section are obtained by process device simulation, and the cross section with the more complex cross-sectional configuration is taken as a two-dimensional cross section. This is more effective in a device with distinct difference in this respect like a NAND flash memory shown in the figure. Furthermore, calculation of parasitic capacitance between floating gates (FG) of a NAND flash memory only requires calculation for an intended cell and its surrounding memory cells. Hence calculation for only a necessary portion can be performed by specifying a range including 3×3 memory cells. This serves to reduce computation time and extra load on the computer, and also leads to reduction of design time.

The three-dimensional configuration along the Y-axis can be also made close to a more realistic configuration by using a suitable way of specifying a range for three-dimensionalization.

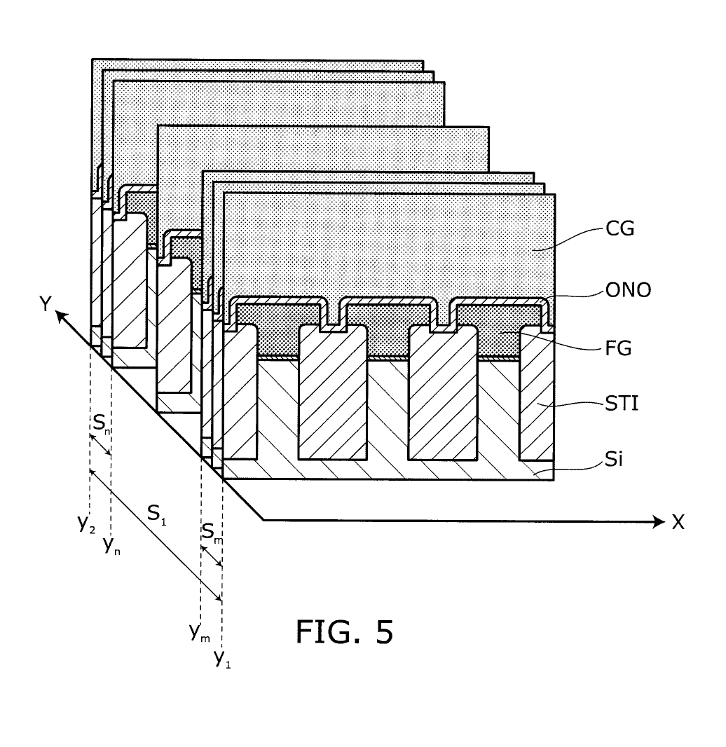

FIG. 5 is a conceptual view showing the method for reproducing an interconnect configuration according to a third embodiment of the invention.

In the figure, the control gate (CG) 1 shown in FIG. 4 is enlarged in the Y-direction. That is, only the range S₁ (y₁≦y≦y₂) is shown. In actual semiconductor devices, the “gouge”, “hollow”, and “rounding” appearing in the X-direction also occur in the Y-direction. These features can be reproduced by finely specifying a range in the Y-direction used for three-dimensionalization.

The control gate (CG) shown in the figure includes a “rounding” at the corner. The range Sₘ (y₁≦y≦yₘ) and the range Sₙ (yₙ≦y≦y₂) having such a “rounding” are specified, and three-dimensionalization is performed along with subdivision in these regions. In the range (yₘ≦y≦yₙ) other than these ranges, the cross-sectional configuration is continuous, and hence subdivision as in the range Sₘ and the range Sₙ is not needed in three-dimensionalization. By combination of the resulting three-dimensional configurations, a more realistic three-dimensional configuration can be reproduced.

Regions subjected and not subjected to fine three-dimensionalization can be specified by using the cross section in the Y-direction obtained by process device simulation. Alternatively, the regions can be specified by empirical decision based on design values. Naturally, the ranges can be changed depending on sites such as the control gate (CG), floating gate (FG), and STI.

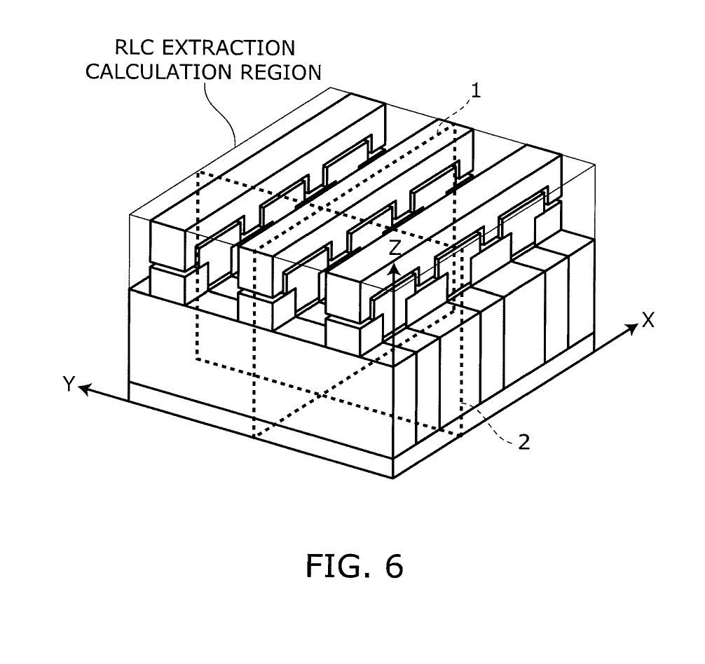

FIG. 6 is a conceptual view showing the method for reproducing an interconnect configuration according to a fourth embodiment of the invention.

The figure shows a memory cell section of a NAND flash memory as in FIG. 4. In a procedure for three-dimensionalizing the interconnect configuration existing in the RLC extraction calculation region shown in the figure, the X-Z cross section 1 is first three-dimensionalized in the Y-direction. Next, the Y-Z cross section 2 is three-dimensionalized in the X-direction. These three-dimensional configurations are compared with each other to determine a final three-dimensional configuration. Thus, by three-dimensionalization in two directions, the data in these directions can be complemented with each other, and a more complex configuration can be reproduced. Also in three-dimensionalizing the Y-Z cross section 2 in the X-direction, the first and second embodiment described above can be arbitrarily used.

In the following, a description is given of a method for calculating electrical characteristics of the interconnect reproduced by the method for reproducing an interconnect configuration according to the first to fourth embodiment described above.

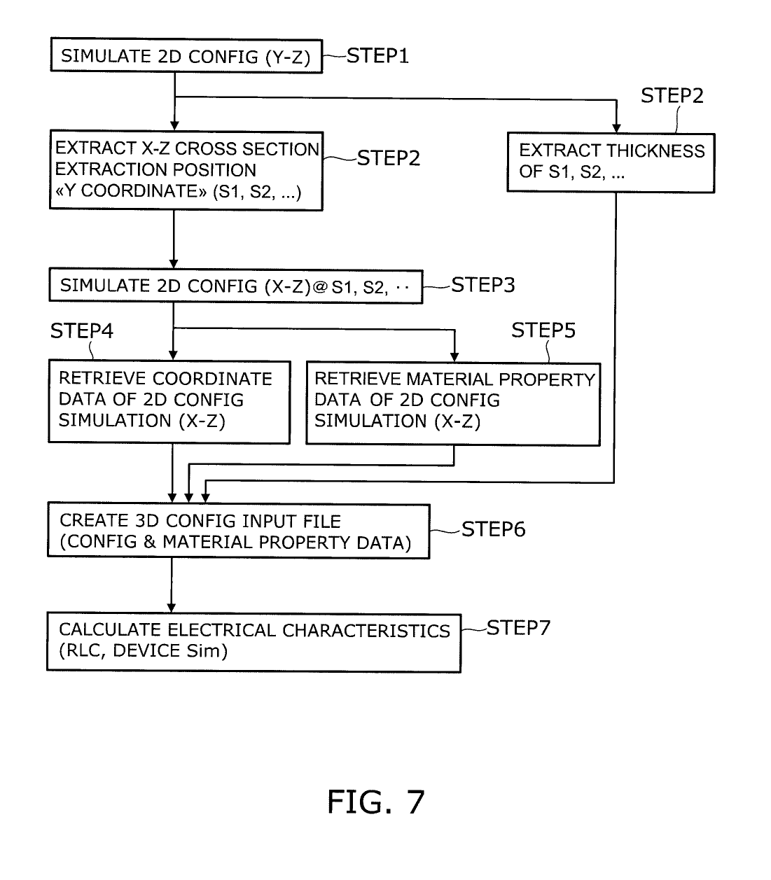

FIG. 7 is a flow chart showing an RLC extraction calculation method according to the embodiment of the invention.

This flow chart is illustrated with reference to RLC extraction calculation for a flash memory shown in FIG. 4.

First, a cross-sectional configuration in the Y-Z direction of the RLC extraction calculation region is calculated (step 1). Here, besides the method of obtaining a cross-sectional configuration based on process device simulation, a method of inferring a cross-sectional configuration from design values by analogy may be used.

Next, from the cross-sectional configuration determined in step 1, a region S₁ (y₁≦y≦y₂) including a control gate (CG) and a region S₂ (y₂≦y≦y₃) not including a control gate are extracted (step 2).

Next, the X-Z cross sections 1 and 2 of the regions S₁ and S₂ determined in step 2, respectively, are calculated (step 3). This calculation is performed by process device simulation.

Next, for each cross-sectional configuration determined in step 3, the coordinate data and the material property data are retrieved (step 4, step 5).

Next, the cross-sectional configurations 1 and 2 determined in step 3 are three-dimensionalized with the region S₁ (y₁≦y≦y₂) and the region S₂ (y₂≦y≦y₃) being specified, and the coordinate data and the material property data for the three-dimensionalized configuration are combined. In a similar procedure, they are combined for interconnects in the RLC extraction calculation region to calculate a three-dimensional configuration of this region (step 6).

Finally, for the three-dimensional configuration of the RLC extraction calculation region determined in step 6, capacitance, resistance, and inductance component are calculated (step 7).

By causing a computer to execute the foregoing steps, an RLC extraction calculation result more close to actual measurements can be obtained.

The embodiments of the invention have been described with reference to the figures. However, the invention is not limited to these embodiments. For example, besides a NAND flash memory, the invention is also applicable to other semiconductor devices, and further applicable to liquid crystal devices. According to the invention, the three-dimensional configuration of a semiconductor device can be realistically reproduced. Hence, besides RLC extraction, the invention is also applicable to three-dimensional device simulation. Furthermore, occasional feedback of simulation results to the manufacturing process serves for cost reduction.

1. A method for designing a semiconductor device including a semiconductor substrate and an interconnect on the semiconductor substrate, with X-direction being one direction parallel to the semiconductor substrate, Y-direction being a direction parallel to the semiconductor substrate and perpendicular to the X-direction, and Z-direction being perpendicular to the semiconductor substrate, the method comprising:
determining a cross-sectional configuration in the X-Z direction;
three-dimensionalizing the cross-sectional configuration with a range in the Y-direction being specified; and
using the three-dimensionalized configuration as a model.

2. The method for designing a semiconductor device according to claim 1, wherein stereoscopic configuration of the interconnect is calculated using the three-dimensionalized configuration as a model.

3. The method for designing a semiconductor device according to claim 1, wherein capacitance, resistance, and inductance component of the interconnect is calculated using the three-dimensionalized configuration as a model.

4. The method for designing a semiconductor device according to claim 1, wherein a cross-sectional configuration in the Y-Z direction is determined and used for determining the range in the Y-direction for three-dimensionalization.

5. The method for designing a semiconductor device according to claim 4, wherein the cross-sectional configuration in the Y-Z direction is used for three-dimensionalizing an end portion of a region, where a given interconnect residing in the cross-sectional configuration in the X-Z direction continuously exists, more finely than the other portion.

6. The method for designing a semiconductor device according to claim 1, wherein the cross-sectional configuration includes at least one of gouge and rounding at a corner of the interconnect.

7. The method for designing a semiconductor device according to claim 1, wherein the cross-sectional configuration in the X-Z direction is more complex than a cross-sectional configuration in Y-Z direction.

8. The method for designing a semiconductor device according to claim 1, wherein the semiconductor device is a flash memory.

9. A method for manufacturing a semiconductor device including a semiconductor substrate and an interconnect on the semiconductor substrate, the interconnect having capacitance, resistance, and inductance component, with X-direction being one direction parallel to the semiconductor substrate, Y-direction being a direction parallel to the semiconductor substrate and perpendicular to the X-direction, and Z-direction being perpendicular to the semiconductor substrate, the method comprising:
determining a cross-sectional configuration in the X-Z direction;
three-dimensionalizing the cross-sectional configuration with a range in the Y-direction being specified;
using the three-dimensionalized configuration as a model to calculate the capacitance, resistance, and inductance component; and
adjusting size of and process for the interconnect so as to optimize the calculated capacitance, resistance, and inductance component.

10. The method for manufacturing a semiconductor device according to claim 9, wherein a cross-sectional configuration in the Y-Z direction is determined and used for determining the range in the Y-direction for three-dimensionalization.

11. The method for manufacturing a semiconductor device according to claim 10, wherein the cross-sectional configuration in the Y-Z direction is used for three-dimensionalizing an end portion of a region, where a given interconnect residing in the cross-sectional configuration in the X-Z direction continuously exists, more finely than the other portion.

12. The method for manufacturing a semiconductor device according to claim 9, wherein the cross-sectional configuration includes at least one of gouge and rounding at a corner of the interconnect.

13. The method for manufacturing a semiconductor device according to claim 9, wherein the cross-sectional configuration in the X-Z direction is more complex than a cross-sectional configuration in Y-Z direction.

14. The method for manufacturing a semiconductor device according to claim 9, wherein the semiconductor device is a flash memory.

15. A software for causing a computer to execute the steps of:
calculating a configuration in a Y-Z cross section, with X-direction being one direction parallel to a semiconductor substrate, Y-direction being a direction parallel to the semiconductor substrate and perpendicular to the X-direction, and Z-direction being perpendicular to the semiconductor substrate;
extracting a thickness S₁ in the Y-direction of a first interconnect and a thickness S₂ in the Y-direction of a second interconnect from the configuration in the Y-Z cross section;
calculating a configuration of the first interconnect in the X-Z cross section;
calculating a configuration of the second interconnect in the X-Z cross section;
calculating a three-dimensional configuration of the first interconnect from the thickness S₁ and the configuration of the first interconnect in the X-Z cross section; and
calculating a three-dimensional configuration of the second interconnect from the thickness S₂ and the configuration of the second interconnect in the X-Z cross section.

16. The software according to claim 15, further causing a computer to execute the step of:
calculating a three-dimensional configuration of a given region by combining the three-dimensional configuration of the first interconnect and the three-dimensional configuration of the second interconnect.

17. The software according to claim 16, further causing a computer to execute the steps of:
retrieving material property data of the first interconnect in the X-Z cross section;
retrieving material property data of the second interconnect in the X-Z cross section;
calculating material property data for the three-dimensional configuration of the first interconnect from the thickness S₁ and the material property data of the first interconnect in the X-Z cross section;
calculating material property data for the three-dimensional configuration of the second interconnect from the thickness S₂ and the material property data of the second interconnect in the X-Z cross section; and
calculating material property data for the three-dimensional configuration of the given region by combining the material property data for the three-dimensional configuration of the first interconnect and the material property data for the three-dimensional configuration of the second interconnect.

18. The software according to claim 16, further causing a computer to execute the step of:
calculating capacitance, resistance, and inductance component of the given region from the material property data for the three-dimensional configuration of the given region.

19. The software according to claim 15, wherein the thickness S₁ is made smaller at a portion where a thickness of the first interconnect varies.

20. The software according to claim 15, wherein the thickness S₂ is made smaller at a portion where a thickness of the second interconnect varies.
